(19) United States
(12) Patent Application Publication
(10) Pub. No.: US 2005/0076182 A1
(43) Pub. Date: Apr. 7, 2005

(54) Memory module

(76) Inventor: Mark W. Minne, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/678,295

(22) Filed: Oct. 3, 2003

(51) Int. Cl. G06F 12/14

(52) U.S. Cl. 711/163

(57) ABSTRACT

Embodiments of the present invention provide a memory module. The memory module includes an adapter region for interfacing the memory module with a host electronic device, a memory component, and an on-card intelligent controller. A fingerprint data security system is in communication with the on-card intelligent controller, configured to identify a user before allowing access to the memory module.

### BACKGROUND OF THE INVENTION

The need for portability and ease in capturing and saving information from various locations away from a user's office or work has resulted in a proliferation of portable electronic devices, such as digital cameras, personal digital assistants, and notebook computers. With the proliferation of portable electronic devices, the use of form factor cards adapted for use with these devices is steadily increasing as well. The term “form factor card” is a general term often used to describe a memory card, such as SONY memory stick or CompactFlash card, but also applies to cards that perform other functions, including Input/Output (I/O) cards such as serial cards, Ethernet cards, fax/modem cards, and multimedia cards.

As this technology evolves, the amount of information that can be saved on form factor cards also increases enabling people to store everything from business records to medical files. The ability to store this kind of sensitive information inherently increases the need for security and restricted access to the information stored on portable computing devices. Traditionally, passwords have been used to prevent unauthorized users from gaining access to the sensitive information on such devices. Even when the passwords are stored in an encrypted file on a portable electronic device such as a personal digital assistant (“PDA”), for example, the information is only secure as long as the form factor card on which the information is stored remains in the PDA. As soon as the form factor card is removed from the PDA and transferred to another PDA, the passwords may be read by anyone who wants access to the information stored on the form factor card.

### SUMMARY OF THE INVENTION

Embodiments of the present invention provide a memory module. In one embodiment, the memory module includes an adapter region for interfacing the memory module with a host electronic device, a memory component, and an on-card intelligent controller. A fingerprint data security system is provided in communication with the on-card intelligent controller, configured to identify a user before enabling access to the memory module.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a diagram illustrating one exemplary embodiment of a computing system comprising a memory module having a fingerprint data security system according to the present invention.

FIG. 2 is a block diagram illustrating one exemplary embodiment of a fingerprint data security system.

FIG. 3 is a diagram illustrating one exemplary embodiment of a memory card having a fingerprint data security system including a sensing window, according to the present invention.

FIG. 4 is a diagram illustrating one exemplary embodiment of a user initializing a memory card according to the present invention.

FIG. 5 is a block diagram illustrating an exemplary embodiment of a memory card having a fingerprint data security system inserted within a host electronic device.

FIG. 6 is a block diagram illustrating one exemplary embodiment of a memory component storing fingerprint data for use with a memory card.

FIG. 7 is a block diagram illustrating another exemplary embodiment of a memory card according to the present invention inserted within a host electronic device.

FIG. 8 is a diagram illustrating one exemplary embodiment of a method of restricting access to a memory card according to the present invention.

### DETAILED DESCRIPTION

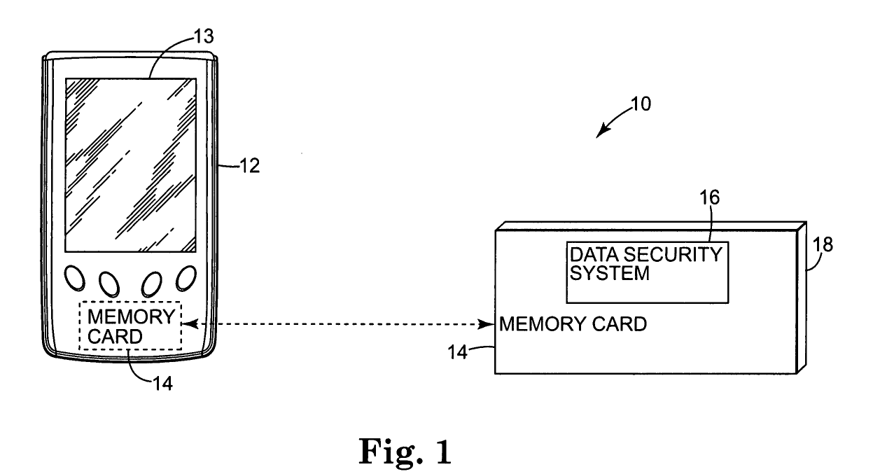

FIG. 1 is a diagram illustrating one exemplary embodiment of a computer system 10 according to the present invention. Computer system 10 includes a memory module or card having an on-card fingerprint data security system for restricting access to storage locations on the memory card. Computer system 10 provides a secure method of storing information. In one embodiment, computer system 10 includes a host electronic device 12 and a memory module or memory card 14. Host electronic device 12 is a device utilizing a memory card (e.g., digital cameras, digital camcorders, personal digital assistants, laptops, and notebook computers or other mobile computing devices). In one exemplary embodiment, host electronic device 12 is a personal digital assistant or “PDA,” as is known in the art, and includes a display 13.

In one embodiment, memory card 14 comprises a fingerprint data security system 16 and housing 18. Data security system 16 is located on memory card 14 and is used to restrict a user's access to memory card 14. In one embodiment, access to memory card 14 includes reading, storing (i.e., writing), or modifying information on memory card 14 via host electronic device 12. Memory card 14 is insertable in different PDAs or other host devices. Fingerprint data security system 16 is part of memory card 14. Regardless of a host device, restricted access is maintained to information stored on memory card 14.

In one embodiment, prior to use in host electronic device 12, an authorized user's biometric fingerprint data (i.e., fingerprint) is stored on memory card 14 via data security system 16. Thus, memory card 14 is irrefutably bound to the authorized user who initialized memory card 14 by storing a representation of a unique biometric of the authorized user on memory card 14. More than one fingerprint may be stored on memory card 14 to enable multiple users to interact with memory card 14 via host electronic device 12. Once memory card 14 is initialized by the authorized user, host electronic device 12 may be used to store information on memory card 14. In one embodiment, for example, the authorized user may store current medical files (e.g., most recent chest x-ray, mammogram, etc.) that would be useful in an emergency. In another embodiment, the authorized user may store his/her financial records on memory card 14. If memory card 14 is lost, stolen, or removed from host electronic device 12 by an unauthorized user, memory card 14 will not function unless a user's fingerprint matches one of the authorized users' fingerprints stored on memory card 14.

In another embodiment, memory card 14 may be programmed to permit itself to be initialized only once. If anyone, including an authorized user, attempts to initialize memory card 14 a second time, memory card 14 will not perform such initialization. Thus, only the authorized user who first initialized memory card 14 is permitted to access memory card 14. In another embodiment, authorized use is tied to groups of data stored on memory card 14. Thus, the user's access to memory card 14 via host electronic device 12 may be restricted by enabling access to one set of information stored on memory card 14, while still restricting access to another set of information stored on memory card 14. In another embodiment, the user's access is restricted to read-only access to the information stored on memory card 14 thereby preventing unauthorized modification of the information accessed by the user.

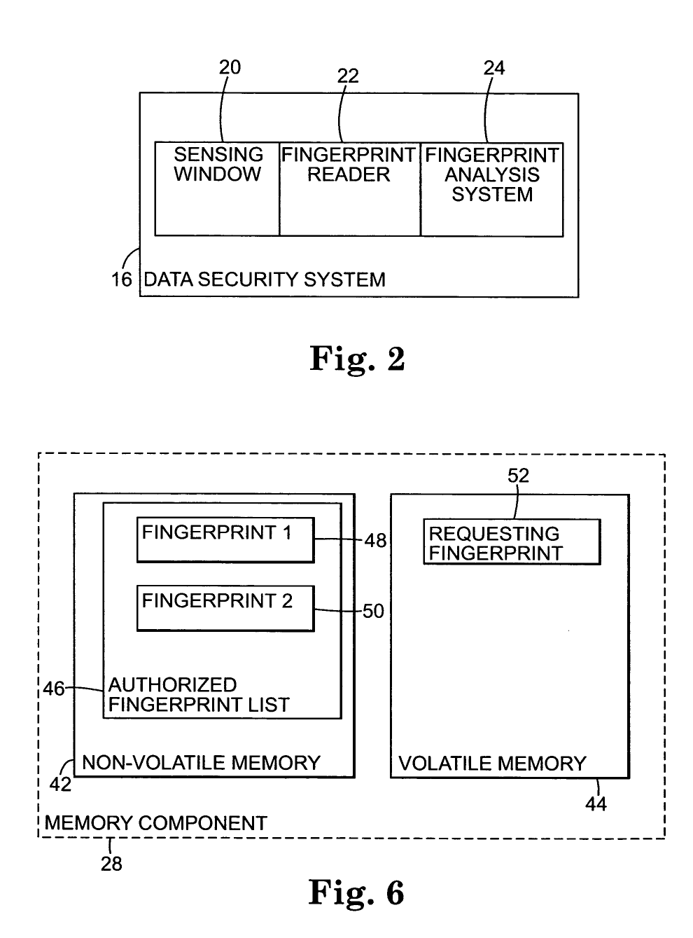

FIG. 2 is a diagram illustrating one exemplary embodiment of data security system 16 for use with memory security system 10 according to the present invention. In one embodiment, data security system 16 comprises a sensing window 20, a fingerprint reader 22, and fingerprint analysis system 24. Sensing window 20 senses the user's fingerprint when the user places a finger on sensing window 20 to cover a portion of sensing window 20. When sensing window 20 senses the user's fingerprint, sensing window 20 interacts with fingerprint reader 22 to generate an electronic fingerprint (i.e., biometric data) representative of the user's fingerprint. The electronic fingerprint is stored on memory card 14. Fingerprint analysis system 24 compares fingerprints received with any stored on memory card 14 to authenticate the identity of the user and determine appropriate access to memory card 14 that should be granted. In one embodiment, memory card 14 restricts access by disabling interaction between host electronic device 12 and memory card 14. In another embodiment, memory card 14 limits access to a memory card 14 via host electronic device 12.

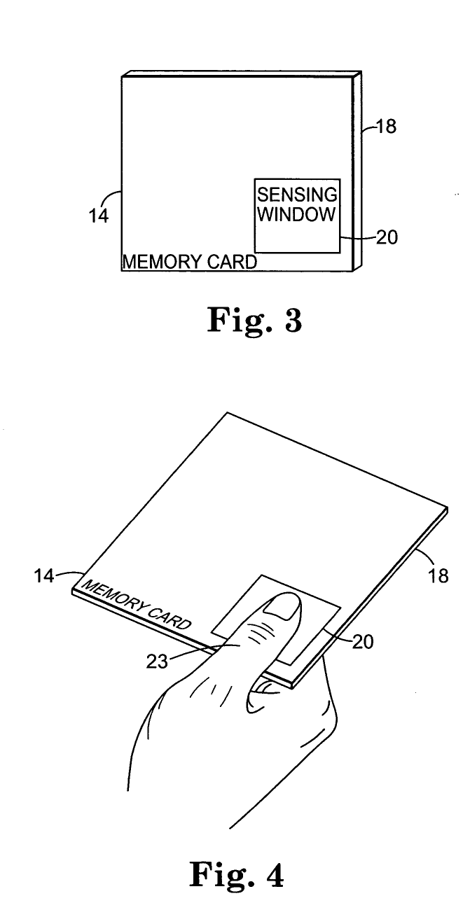

FIG. 3 is a diagram illustrating one exemplary embodiment of memory card 14 according to the present invention. In one embodiment, memory card 14 is a form factor card, comprising housing 18 and a sensing window 20. Sensing window 20 constitutes part of a fingerprint reader that is configured to generate an electronic fingerprint when the user places a finger on sensing window 20. In one embodiment, sensing window 20 is located along the surface of housing 18 of memory card 14 such that a user's finger will naturally at least partially cover sensing window 20 when the user holds memory card 14 in his/her hand to install memory card 14 into host electronic device 12. In another embodiment, sensing window 20 is maintained outside of a host device after insertion of memory card 14 into the host device. This configuration enables user authorization or “initialization” of memory card 14 to take place after insertion of memory card 14 into the host device.

FIG. 4 is a diagram illustrating one exemplary embodiment of the user initializing memory card 14. The user initializes memory card 14 by storing the user's unique biometric (e.g., a fingerprint) on memory card 14. To store the fingerprint, the user holds memory card 14 such that the user's finger 23 covers a portion of sensing window 20. In one embodiment, the user's finger is a thumb. In another embodiment, the user's finger is an index finger.

In one embodiment, when the user first holds memory card 14, the user's fingerprint is automatically captured and stored on memory card 14 prior to the user installing memory card 14 into host electronic device 12. The terms “capturing” or “receiving” a fingerprint as used herein means capturing an image or data about the fingerprint, or both. In one embodiment, sensing window 20 includes a matrix of columns and rows of pixels that each can detect contact with a ridge of the user's fingertip. When the user's finger is placed over sensing window 20, memory card 14 generates an electronic fingerprint representative of the user's fingerprint via data security system 16 and stores the electronic fingerprint on memory card 14. Once the user's identity has been authenticated via data security system 16 of memory card 14, memory card 14 notifies host electronic device 12 to enable the user to access memory card 14.

In one embodiment, the user's fingerprint can be identified by detecting the presence and location of a number of characteristics. In one embodiment, fingerprint analysis system 24 detects the presence and location of deltas, as are known in the art. For example, deltas formed where three fingerprint ridge lines almost come together are analyzed in relation to the center of the fingerprint impression known in the art as the core. In another embodiment, other characteristics such as the distance between ridges, etc., can be detected.

In another embodiment, when the user grasps memory card 14, oils from the user's finger 22 are left on sensing window 20 of memory card 14 creating a print. When memory card 14 is installed in host electronic device 12, the memory card 14 translates the print left on sensing window 20 by the user's finger 22 into the electronic fingerprint stored on memory card 14. Other suitable print identification methods for use with the present invention will become apparent to one skilled in the art after reading the present application.

Additionally, the memory card can be powered via the host electronic device 12. Thus, memory card 12 does not need a separate (i.e., independent) power source to capture the user's fingerprint.

In one embodiment, if fingerprint system 16 does not receive the user's fingerprint prior to memory card 14 being installed in host electronic device 12, memory card 14 will not initialize to enable the user to access memory card 14.

In another embodiment, memory card 14 is first installed in host electronic device 12. The user's fingerprint is downloaded into host electronic device 12. Host electronic device 12 then transfers the user's fingerprint to memory card 14 as part of a process of initializing memory card 14. When memory card 14 is removed from host electronic device 12, the user's fingerprint received by sensing window 20 when memory card 14 is reinstalled in another host electronic device 12 must match the user's fingerprint that was stored on memory card 14.

In one embodiment, the user's finger print or fingerprint data is stored on a remote system and is obtained via a communication link. The communication link, as used herein, is defined to include an internet communication link (e.g., the Internet), an intranet communication link or other high-speed communication link. In one preferred embodiment, the communication link includes an Internet communication link. It is understood that the use of other network communication links is within the scope of the present invention.

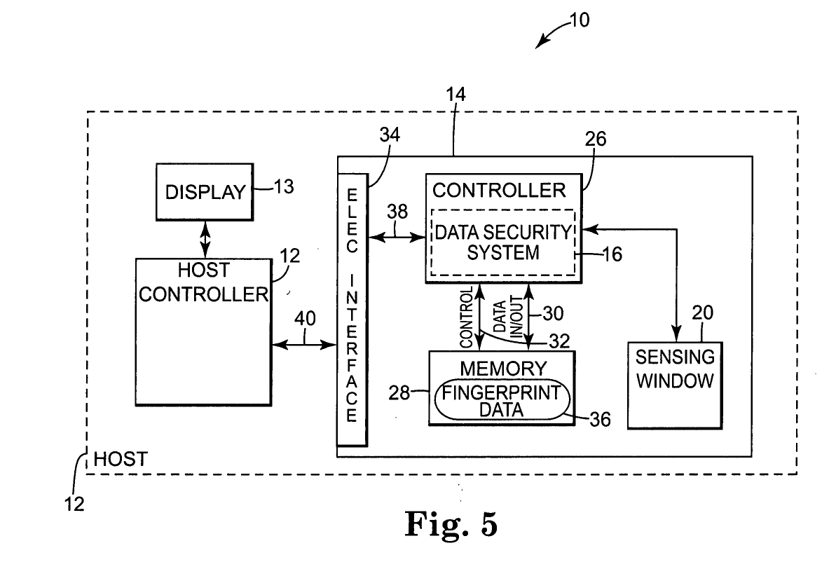

FIG. 5 is a block diagram illustrating one exemplary embodiment of memory card 14, according to the present invention as inserted within host electronic device 12. In one embodiment, memory card 14 is a form factor card, as is known in the art, which is installed and engaged by host electronic device 12. In one embodiment, memory card 14 comprises data security system 16, sensing window 20, on-card, intelligent controller 26, a memory component 28, data channels 30, control channels 32, and an electrical interface 34 for connection to host electronic device 12. In one embodiment, memory card 14 is a compact flash storage card designed according to the CFt and compact flash specification of Compact Flash Association (www.compactflash.org). The CFt and compact flash specification is herein incorporated by reference. On-card intelligent controller 26 processes signals from data security system 16 to generate the electronic fingerprint and store the electronic fingerprint in the form of fingerprint data 36 in memory component 28. On-card intelligent controller 26 communicates with host electronic device 12, including display 13, via electrical interface 34 and interface channels 38 and 40. On-card intelligent controller 26 also manages interface protocols with host electronic device 12, data storage and retrieval, diagnostics, defect handling, error correction, and power management and clock control functions. In one embodiment, on-card intelligent controller 26 is a microprocessor.

In one embodiment, interface channels 40 transfer data between host electronic device 12 and memory card 14. In the installed position, as illustrated in FIG. 1, host interface channels 40 are engaged with electrical interface 34. Host interface channels (i.e., bus) 40 transfer data between host electronic device 12 and memory card 14 and provide electrical power to memory card 14 via electrical interface 34 and interface channels 38.

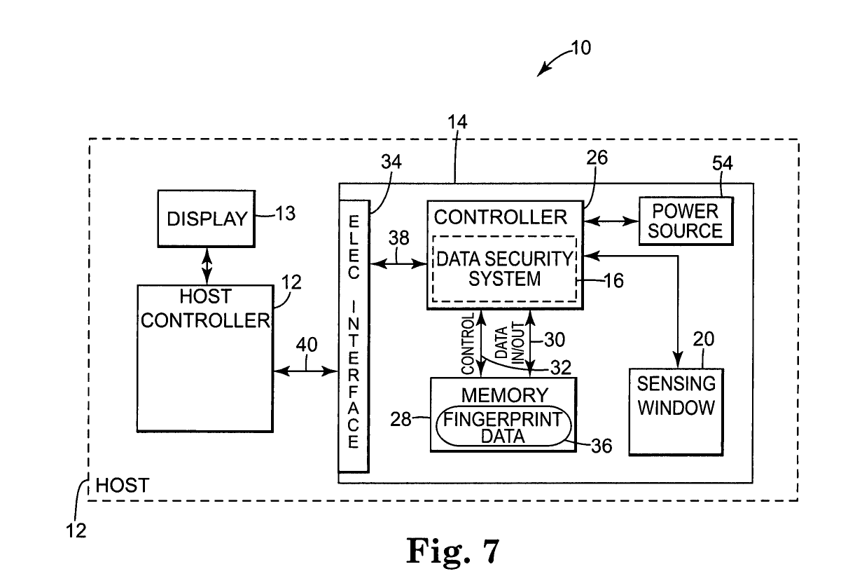

FIG. 6 is a diagram illustrating one exemplary embodiment of memory component 28 storing fingerprint data 36. In one embodiment, memory component 28 includes a nonvolatile memory 42 and a volatile memory 44. Suitable memory includes, but is not limited to, flash memory and magnetic random access memory (MRAM), atomic resolution storage devices, or other persistent storage device such as a micro disk drive. Fingerprint data 36 is stored in both nonvolatile memory 42 and volatile memory 44. In one embodiment, fingerprint data 36 comprises an authorized fingerprint list 46 that contains a first authorized fingerprint 48 and a second authorized fingerprint 50, and a request fingerprint 52. When memory card 14 is first initialized, authorized fingerprint list 46, including first authorized fingerprint 48 and second authorized fingerprint 50, is stored in non-volatile memory 42. If memory card 14 is removed from host electronic device 12, requesting fingerprint 52 may be received via sensing window 20 of data security system 16 before the user installs memory card 14 into another host electronic device 12. Once requesting fingerprint 52 is received, it is translated into an electronic fingerprint by fingerprint reader 22 and stored in volatile memory 44 of memory component 28. On-card intelligent controller 26 interacts with memory component 28 via data security system 16 to compare requesting fingerprint 52 with authorized fingerprint list 42 stored in nonvolatile memory 42 when memory card 14 was first initialized by the user. If requesting fingerprint 52 matches first authorized fingerprint 48 or second authorized fingerprint 50 on authorized fingerprint list 46, on-card intelligent controller 26 determines the appropriate access to memory card 14 based on the comparison and enables the user to access memory card 14.

In one embodiment, memory card 14 is configured to delay informing host electronic device 12 that memory card 14 is ready for engagement until memory card 14 has established the user's identity. The particular manner in which engagement of memory card 14 by host electronic device 12 can be suspended so that memory card 14 can establish the user's identity depends on an operating system software and/or host electronic device 12 interface. In one embodiment, host electronic device 12 waits for confirmation that memory card 14 installed in host electronic device 12 is ready for further interaction with the operating system software of host electronic device 12 before host electronic device attempts to identify memory card 14.

FIG. 7 is a block diagram illustrating one exemplary embodiment of host electronic device 12 having memory card 14 according to the present invention. In this embodiment, memory module 14 is a form factor card that is installed and engaged by host electronic device 12. In one embodiment, memory card 14 comprises on-card intelligent controller 26, data security system 16, memory component 28, data channels 30, control channels 32, electrical interface 34 for connection to host electronic device 12 and a power source 54. When memory card 14 receives the user's fingerprint, e.g., via sensing window 20, memory card 14 translates the user's fingerprint into an electronic fingerprint and stores the electronic fingerprint in memory component 28 via on-card intelligent controller 26. Memory card 14 is not dependent on host electronic device 12 for electrical power needed to capture and store the user's fingerprint on memory card 14 due to on-board power source 54. When memory card 14 is installed in host electronic device 12, on-card intelligent controller 26 of memory card 14 uses power from host electronic device 12 to authenticate the user's identity. Once the user's identity has been authenticated, memory card 14 sends a signal to host electronic device 12 that memory card 14 is ready to interact with host electronic device 12 to enable the user to access memory card 14 via host electronic device 12.

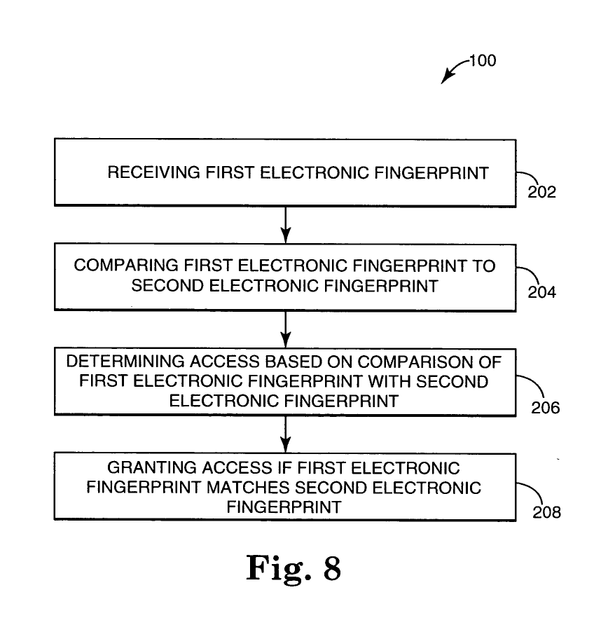

FIG. 8 is a flow diagram illustrating one exemplary embodiment of a method of protecting information stored on memory card 14. The method of protecting information stored on memory card 14, according to the present invention, is generally illustrated at 100. Reference is also made to FIGS. 1-7. At 202, memory card 14 receives a first electronic fingerprint (e.g., a whole fingerprint or portion of a fingerprint). In one embodiment, memory card 14 receives the first electronic finger print via data security system 16 when the user places a finger on sensing window 20 to cover a portion of sensing window 20 of memory card 14. Fingerprint reader 22 of data security system 16 translates the user's fingerprint into the first electronic fingerprint and stores the first electronic fingerprint (similar to authorized fingerprints 48 and 50) in authorized fingerprint list 46. In another embodiment, memory card 14 is first installed in host electronic device 12 and host electronic device 12 transfer's the first electronic fingerprint (similar to authorized fingerprints 48 and 50) to memory card 14 from a website.

At 204, on-card intelligent controller 26 compares the first electronic fingerprint (e.g., authorized fingerprints 48 and 50) with a second electronic fingerprint (e.g., requesting fingerprint 52). In one embodiment, if memory card 14 is removed from host electronic device 12, the user places his/her finger on sensing window 20 prior to reinstalling memory card 14 into host electronic device 12, or after installation but before memory card 14 grants access. On-card intelligent controller compares the first electronic fingerprint with the second electronic fingerprint via fingerprint analysis system 24 of data security system 16 (or vice versa) to identify the user and determine whether to enable access to memory card 14.

At 206, memory card 14 determines access based on the comparison of the first fingerprint to the second fingerprint. In one embodiment, for example, the user may be authorized to access only limited information on memory card 14. In another embodiment, the user may be authorized to read the information stored on memory card 14, but not authorized to modify the viewed information stored on memory card 14.

At 208, memory card 14 enables access to memory card 14 if the user's identity is authenticated via data security system 16. In one embodiment, the user's identity is authenticated when the first fingerprint stored on memory card 14 when the user initialized memory card 14 matches the second fingerprint provided by the user when the user wishes to interact with memory card 14 to access, store or modify the information on memory card 14 after reinstallation of memory card 14 into another host electronic device 12. Thus, if memory card 14 is lost, stolen, or removed, an unauthorized user cannot gain access to memory card 14 by simply inserting memory card 14 into another host electronic device. Other additional restrictions may be utilized to limit access to information on memory card 14 once authenticated and installed into a host device. For example, re-authentication may be required after a predefined amount of time has passed and the memory card is still inserted into the host device.

One exemplary embodiment of a memory card 14 comprises an atomic resolution storage device configured for use in memory card 14 having a fingerprint data security system according to the present invention, and capable of storing megabytes to gigabytes of information in a small storage area. For a further discussion of one embodiment of a suitable atomic resolution storage device, see U.S. Pat. No. 5,557,596, entitled, “Ultra-High Density Storage Device”, by Gibson et al. and assigned to Hewlett-Packard Company, and U.S. patent application Ser. No. 09/617,876, by Si-Ty Lam et al., filed Jul. 17, 2000, entitled “Self-Aligned Electron Source Device” both of which incorporated herein by reference.

1. A memory module compatible for use with a host electronic device, the memory module comprising:
a memory component;
an on-board intelligent controller; and
a fingerprint data security system in communication with the on-board intelligent controller configured to identify a user before enabling access to the memory module.

2. The memory module of claim 1, where the memory component is an atomic resolution storage device.

3. The memory module of claim 2, the atomic resolution storage device comprising a plurality of field emitters, a storage medium located in proximity to the field emitters, and micromover for moving the field emitters relative to the storage medium.

4. The memory module of claim 1, further comprising an adapter region for interfacing the memory module with the host electronic device;

5. The memory module of claim 1, further comprising a power source.

6. The memory module of claim 1, wherein the memory module is a removable memory, and wherein the on-board intelligent controller controls access to the removable memory.

7. The memory module of claim 1, wherein the on-board intelligent controller includes the fingerprint data security system.

8. The memory module of claim 1, wherein the on-board intelligent controller stores fingerprint data in the memory component.

9. The memory module of claim 8, wherein the on-board intelligent controller receives the fingerprint data from a network site via the host electronic device.

10. A memory module compatible for use with a host electronic device, the memory module comprising:
a memory component;
an on-board intelligent controller; and
a fingerprint data security system in communication with the on-board intelligent controller configured to identify a user before enabling access to the memory module, wherein the fingerprint data security system comprises an authorized fingerprint list and a requesting fingerprint list.

11. The memory module of claim 10, wherein the fingerprint data security system comprises a fingerprint analysis system, and wherein the on-board intelligent controller compares the requesting fingerprint with the authorized fingerprint list via the fingerprint analysis system.

12. The memory module of claim 10, wherein the memory component comprises a nonvolatile memory, and wherein the on-board intelligent controller stores the authorized fingerprint list in the nonvolatile memory.

13. The memory module of claim 10, wherein the memory component comprises a volatile memory, and wherein the on-board controller stores the requesting fingerprint in the volatile memory.

14. The memory module of claim 10, wherein the authorized fingerprint list comprises at least one authorized fingerprint.

15. A memory module compatible for use with a host electronic device, the memory module comprising:
a memory component;
an on-board intelligent controller; and
a fingerprint data security system in communication with the on-board intelligent controller configured to identify a user before enabling access to the memory module where, the fingerprint data security system includes a fingerprint reader.

16. The memory module of claim 15, wherein the fingerprint reader receives a user's fingerprint and generates a requesting fingerprint representative of the user's fingerprint.

17. The memory module of claim 15, wherein the fingerprint reader includes a sensing window for receiving a user's fingerprint.

18. The memory module of claim 17, wherein the user's finger covers at least a portion of the sensing window.

19. The memory module of claim 18, where the user's finger covers a portion of the sensing window when the user holds the memory module.

20. The memory module of claim 15, where the memory module is a memory card.

21. A method of protecting information stored on a memory card, the method comprising:
comparing an electronic fingerprint stored on the memory card to a later received electronic fingerprint;
determining access based on a comparison of the first electronic fingerprint with the received electronic fingerprint; and
granting access to the memory card if the stored electronic fingerprint matches the received electronic fingerprint.

22. The method of claim 21, wherein comparing the stored electronic fingerprint comprises using an on-card data security system.

23. The method of claim 21, wherein comparing the stored electronic fingerprint comprises using a fingerprint reader to receive the received electronic fingerprint.

24. The method of claim 22, wherein using a fingerprint reader comprises using a sensing window to receive the received electronic fingerprint.

25. The method of claim 21, comprising receiving the stored electronic fingerprint from a network site via a host electronic device.

26. The method of claim 21, comprises receiving the stored electronic fingerprint comprising defining an authorized fingerprint list to include the stored electronic fingerprint.

27. The method of claim 21, comprising receiving the stored electronic fingerprint comprising storing the stored electronic fingerprint on the memory card.

28. The method of claim 21, wherein comparing the stored electronic fingerprint to the received electronic fingerprint includes storing the received electronic fingerprint on the memory card.

29. The method of claim 21, wherein determining access based on the comparison of the stored electronic fingerprint to the received electronic fingerprint comprises determining access via an on-card intelligent controller.

30. A memory card compatible for use with a host electronic device, the memory card comprising:
an adapter region for interfacing the memory module with the host electronic device;
an on-card intelligent controller;
a memory component, comprising an atomic resolution storage device configured to communicate with the on-card intelligent controller as a redundant array of independent storage devices, where the atomic resolution storage device is a non-volatile memory component including a plurality of electron emitters, a media having media partitions, and a plurality of micromovers wherein each micromover is independently operable to move a media partition relative to one or more electron emitters for reading and writing data at the media; and
a fingerprint data security system in communication with the on-card intelligent controller configured to identify a user before allowing access to the memory card.

31. A mobile computing system, comprising:
a mobile computing device;
a memory module in communication with the mobile computing device comprising:
a memory component, an on-board intelligent controller, and a data security system in communication with the on-board intelligent controller configured to identify a user before allowing access to the memory module.

32. The system of claim 31, further comprising:
an adapter region for interfacing the memory module with the mobile computing device.

33. The system of claim 31, wherein the memory module is a form factor memory card.

34. The mobile computing device of claim 30, wherein the mobile computing device is a personal digital assistant.

35. A computer-readable medium having computer-readable instructions for performing a method of protecting information stored on a memory module, the instructions comprising:
logic for comparing an electronic fingerprint stored in the memory module to a received electronic fingerprint;
logic for determining access based on a comparison of the stored electronic fingerprint with the received electronic fingerprint; and
logic for granting access to the memory memory module if the stored electronic fingerprint matches the received electronic fingerprint.
